(19) United States
(12) Patent Application Publication
(10) Pub. No.: US 2009/0295710 A1
(43) Pub. Date: Dec. 3, 2009

(54) ELECTROPHORETIC DISPLAY DEVICE AND ELECTRONIC APPARATUS

(75) Inventor: Yasuhiro SHIMODAIRA, Munich (DE)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/420,914

(22) Filed: Apr. 9, 2009

(30) Foreign Application Priority Data
May 29, 2008 (JP) 2008-141149

(51) Int. Cl. G09G 3/34

(52) U.S. Cl. 345/107

(57) ABSTRACT

There is provided an electrophoretic display device that is formed by pinching an electrophoretic element containing electrophoretic particles between one pair of substrates. The electrophoretic display device includes a display unit that is formed of a plurality of pixels. One substrate of the one pair of substrates includes a pixel electrode and a pixel switching element that are formed for each of the plurality of pixels, a memory circuit that is electrically connected between the pixel electrode and the pixel switching element and can hold an image signal supplied through the pixel switching element, and an electrostatic protection unit that is electrically connected between the pixel electrode and the memory circuit and is formed of at least one of a capacitor element, a resistor element, and a diode.

### BACKGROUND

1. Technical Field

The present invention relates to an electrophoretic display device, and an electronic apparatus comprising the electrophoretic display device.

2. Related Art

In electrophoretic display devices of this type, a display unit that performs display by using a plurality of pixels as described below is included. In each pixel, after an image signal is written into a memory circuit through a pixel switching element, a pixel electrode is driven in accordance with an electric potential corresponding to the written image signal, and whereby an electric potential difference between a common electrode and the pixel electrode is generated. Accordingly, an electrophoretic element disposed in the pixel electrode and the common electrode is driven, and whereby display is performed (for example, see JP-A-2003-84314).

Based on the research conducted by inventors of the invention and the like, in order to drive an electrophoretic element, a pixel circuit having a switching circuit is build in addition to a memory circuit that includes a pixel switching element and an SRAM (static random access memory) for each pixel, and display is performed by the pixel circuit in the display unit. This pixel circuit is configured to be able to supply the electric potential to the pixel electrode, separately from writing an image signal into the memory circuit. According to such a pixel circuit, compared to the above-described pixel circuit disclosed in JP-A-2003-84314, the pixels can be driven at low power consumption, and generation of a leakage current between adjacent pixels of which pixel electrodes have different electric potentials can be prevented more effectively.

In the device that performs display by supplying an electric potential to the pixel electrode, separately from writing the image signal into the memory circuit, an electric potential difference generated in a manufacturing process is applied to elements such as transistors, for example, that configure the switching circuit, the memory circuit, and the like through the pixel electrode. As a result, there is a technical problem that the elements may be damaged due to electrostatic discharge.

### SUMMARY

An advantage of some aspects of the invention is that it provides an electrophoretic display device capable of effectively preventing damages of elements due to electrostatic discharge in a manufacturing process and an electronic apparatus having the electrophoretic display device.

According to a first aspect of the invention, there is provided an electrophoretic display device that is formed by pinching an electrophoretic element containing electrophoretic particles between one pair of substrates. The electrophoretic display device includes a display unit that is formed of a plurality of pixels. One substrate of the one pair of substrates includes: a pixel electrode and a pixel switching element that are formed for each of the plurality of pixels; a memory circuit that is electrically connected between the pixel electrode and the pixel switching element and can hold an image signal supplied through the pixel switching element; and an electrostatic protection unit that is electrically connected between the pixel electrode and the memory circuit and is formed of at least one of a capacitor element, a resistor element, and a diode.

According to the above-described electrophoretic display device, in its operation, a voltage corresponding to an image signal is applied to the electrophoretic element that is pinched by one pair of substrates, between a pixel electrode formed on one substrate of one pair of substrates that is, for example, a component substrate for each pixel and, for example, a common electrode formed on the other substrate of one pair of substrates that is, for example, an opposing substrate, for example, in a beta form, and whereby an image is displayed in the display unit.

In particular, inside the electrophoretic element that is, for example, a microcapsule, as the electrophoretic particles, for example, a plurality of white particles negatively charged and a plurality of black particles positively charged are included. In the electrophoretic apparatus, according to a voltage applied between the pixel electrode and the common electrode, one group between the plurality of white particles negatively charged and the plurality of black particles positively charged is moved (that is, electrophoresis) to the pixel electrode side, and the other group is moved to the common electrode side. Accordingly, an image according to moved electrophoretic particles is displayed on the other substrate side (that is, the common electrode side) of one pair of substrates.

For example, a plurality of pixel electrodes is disposed in a matrix shape in correspondence with intersections of data lines and scanning lines that are disposed on the substrate so as to intersect with each other. In each pixel in which the pixel electrode is disposed, a transistor as a pixel switching element and a memory circuit that holds an image signal supplied through the pixel switching element are disposed for each pixel. Here, the memory circuit, for example, includes a plurality of transistors and is configured to hold the image signal by being supplied with a holding electric potential.

According to the above-described electrophoretic display device, particularly, the electrostatic protection unit that is electrically connected between the pixel electrode and the memory circuit is included. The electrostatic protection unit is formed of at least one of a capacitor element, a resistor element, and a diode. By using the electrostatic protection unit, even when static electricity is applied to the pixel electrode in the manufacturing process of the electrophoretic display device, a damage of an element such as a transistor that configures the memory circuit due to electrostatic discharge can be prevented.

For example, in the capacitor element, a dielectric film is pinched between one capacitor electrode that is electrically connected to a wiring electrically connecting the memory circuit and the pixel electrode and another capacitor electrode that is electrically connected to other wirings such as a holding electric potential supplying line for supplying a holding electric potential for holding the image signal to the memory circuit or a ground electric potential line for supplying a ground electric potential. By disposing the capacitor element, a current flowing between the pixel electrode and the memory circuit is used for charging the capacitor element, and accordingly, a current flowing into the memory circuit can be decreased.

The resistor element is disposed on a wiring between the memory circuit and the pixel electrode. Alternatively, by forming the wiring or the pixel electrode with a high-resistance material or covering the pixel electrode with a high-resistance cover, a same advantage can be acquired. By disposing the resistance element, a current flowing between the pixel electrode and the memory circuit can be decreased.

The diode is disposed between a wiring between the memory circuit and the pixel electrode and another wiring. Typically, two diodes including one for allowing a current to flow from the wiring between the memory circuit and the pixel electrode to another wiring and the other for allowing a current to flow from another wiring to the wiring between the memory circuit and the pixel electrode are disposed. By disposing the diode, the current flowing between the pixel electrode and the memory circuit can be allowed to flow out to another wiring partially at least. Accordingly, the current flowing into the memory circuit can be decreased.

By configuring the electrostatic protection unit so as to include a plurality of the capacitor elements, the resistor elements, and the diodes, a higher effect can be exhibited. In other words, the current flowing into the memory circuit from the pixel electrode side can be decreased further. By increasing the capacitance of the capacitor element or increasing the resistance of the resistor element, a same advantage can be acquired. Furthermore, by combining the capacitor element, the resistor element, and the diode, a high effect can be exhibited.

As described above, according to the electrophoretic display device, the electrostatic protection unit that is electrically connected between the pixel electrode and the memory circuit and is configured to include at least one of the capacitor element, the resistor element, and the diode is included. Thus, even when static electricity is applied to the pixel electrode in the manufacturing process of the device, it can be effectively prevented that elements configuring the memory circuit are damaged due to electrostatic discharge.

The above-described electrophoretic display device may further include a switching circuit that electrically connects either a first control line or a second control line to the pixel electrode in accordance with an output signal on the basis of the image signal that is output from the memory circuit. In this case, the electrostatic protection unit is electrically connected between the pixel electrode and the switching circuit.

In such a case, the switching circuit is disposed between the memory circuit and the pixel electrode. The switching circuit electrically connects any between the first control line and the second control line, which supply different electric potentials, to the pixel electrode in accordance with the output signal output from the memory circuit based on the image signal. In particular, the switching circuit, for example, is formed to include a plurality of switching elements so as to switch a control line electrically connected to the pixel electrode between the first control line for supplying a first pixel electric potential and the second control line for supplying a second pixel electric potential different from the first electric potential, in accordance with the output from the memory circuit. Accordingly, the first pixel electric potential is supplied to the pixel electrode, which is electrically connected to the first control line, through the first control line. In addition, the second pixel electric potential is supplied to the pixel electrode, which is electrically connected to the second control line, through the second control line.

In the above-described electrophoretic display device, a current flows from the pixel electrode to the switching circuit due to static electricity generated in the pixel electrode. In other words, first, the current generated due to the static electricity flows into the switching circuit rather than the memory circuit. In the above-described electrophoretic display device, particularly, the electrostatic protection unit is electrically connected between the pixel electrode and the switching circuit, and accordingly, the current flowing into the switching circuit can be decreased. Accordingly, it can be prevented that the electric potential of the switching circuit increases abruptly. In addition, since the current flowing into the memory circuit from the switching circuit can be decreased, it can be prevented that the electric potential of the memory circuit increases abruptly. As a result, damages of the elements configuring the memory circuit and the switching circuit due to electrostatic discharge in the manufacturing process can be prevented effectively.

The above-described electrophoretic display device may further include a holding electric potential supplying line that is used for supplying a holding electric potential for holding the image signal to the memory circuit. In this case, the electrostatic protection unit includes a first capacitor element that is formed by pinching a dielectric film between one capacitor electrode that is electrically connected to the pixel electrode and another capacitor electrode that is electrically connected to the holding electric potential supplying line.

In such a case, the current flowing into the memory circuit due to static electricity applied to the pixel electrode can be decreased by using the first capacitor element. Accordingly, damages of the elements configuring the memory circuit due to electrostatic discharge in the manufacturing process can be prevented effectively.

For a case where the device does not include any switching circuit, when the device is driven, almost the same or exactly the same electric potential (that is, the holding electric potential) is supplied to the wiring disposed between the pixel electrode and the memory circuit and the holding electric potential supplying line. Accordingly, between one capacitor electrode configuring the first capacitor element and another capacitor electrode, a voltage is scarcely applied or is not applied at all. As a result, in the driving process, the first capacitor element is scarcely charged or is not charged at all. As a result, in the driving process, power consumption due to charge of the capacitor element can be reduced.

In the above-described electrophoretic display device having the above-described switching circuit, the electrostatic protection unit may be configured to include a second capacitor element that is formed by pinching a dielectric film between one capacitor electrode that is electrically connected to the pixel electrode and another capacitor electrode that is electrically connected to either the first control line or the second control line.

In such a case, the current flowing into the switching circuit due to the static electricity that is applied to the pixel electrode can be decreased by using the second capacitor element. Accordingly, damages of the elements configuring the switching circuit due to electrostatic discharge in the manufacturing process can be prevented effectively.

In the above-described electrophoretic display device, the electrostatic protection unit may be configured to include a first resistor element that is formed of a same film as a semiconductor film that configures a transistor included in the memory circuit.

In such a case, the first resistor element is formed of a same film as a semiconductor film such as a Si (silicon) film that configures a transistor that is included in the memory circuit. Here, the “same film” represents a film that is formed at the same time in the manufacturing process and is a film of a same type. Here, “formed of a same film” does not require to be continuously formed as one film, and it is sufficient that film portions are formed by dividing a basically same film.

By forming the resistor element of a same film as the semiconductor film that configures the transistor included in the memory circuit, a semiconductor film configuring the transistor that is included in the memory circuit and the first resistor element can be formed by performing a same film-forming process. Accordingly, it is possible to simplify the manufacturing process of the device. In addition, it can be prevented to increase the complexity of the structure of the device.

In the above-described electrophoretic display device, it may be configured that the electrostatic protection unit includes the resistor element and at least one between the capacitor element and the diode, and the resistor element is disposed on a side close to the pixel electrode relative to the capacitor element and the diode so as to be electrically connected to the pixel electrode.

In such a case, the resistor element is disposed on a side close to the pixel electrode relative to the capacitor element and the diode so as to be electrically connected to the pixel electrode.

In a case where the resistor element and the capacitor element or the diode are disposed in the described order, when static electricity is generated in the pixel electrode, first, a current flows into the resistor from the pixel electrode. Then, a decreased current due to resistance flows into the capacitor element or the diode. Accordingly, the current flowing into the memory circuit side from the pixel electrode can be decreased more effectively.

Regarding the capacitor element and the diode, it is preferable that the capacitor element is disposed to a side close to the pixel electrode relative to the diode. Thus, in order to combine three elements including the resistor element, the capacitor element, and the diode, it is preferable that the resistor element, the capacitor element, and the diode are disposed in the described order from the pixel electrode side.

According to a second aspect of the invention, there is provided an electronic apparatus including the above-described electrophoretic display device (including the various forms).

According to the above-described electronic apparatus, the above-described electrophoretic display device is included. Therefore, various electronic apparatuses such as a wrist watch, an electronic paper sheet, an electronic notebook, a cellular phone, and a mobile audio instrument that can be manufactured in an easy manner and have high reliability can be implemented.

The operation and other advantages of the invention will be disclosed in the following description of exemplary embodiments.

### BRIEF DESCRIPTION OF THE DRAWINGS

The invention will be described with reference to the accompanying drawings, wherein like numbers reference like elements.

FIG. 1 is a block diagram showing the whole configuration of an electrophoretic display device according to a first embodiment of the invention.

FIG. 2 is a partial cross-section view of a display unit of the electrophoretic display device according to the first embodiment.

FIG. 3 is a schematic diagram showing the configuration of a microcapsule.

FIG. 4 is an equivalent circuit diagram showing the electrical configuration of a pixel of the electrophoretic display device according to the first embodiment.

FIG. 5 is an equivalent circuit diagram showing a first modified example of an electrophoretic display device according to the first embodiment.

FIG. 6 is an equivalent circuit diagram showing a second modified example of an electrophoretic display device according to the first embodiment.

FIG. 7 is an equivalent circuit diagram showing a third modified example of an electrophoretic display device according to the first embodiment.

FIG. 8 is an equivalent circuit diagram showing the electrical configuration of a pixel of the electrophoretic display device according to the second embodiment.

FIG. 9 is an equivalent circuit diagram showing the electrical configuration of a pixel of the electrophoretic display device according to the third embodiment.

FIG. 10 is an equivalent circuit diagram showing the electrical configuration of a pixel of the electrophoretic display device according to the fourth embodiment.

FIG. 11 is a perspective view showing the conceptual connection configuration of a pixel electrode, a resistor element, and a transistor configuring a switching circuit according to an embodiment of the invention.

FIG. 12 is an equivalent circuit diagram showing a modified example of an electrophoretic display device according to a fourth embodiment of the invention.

FIG. 13 is an equivalent circuit diagram showing the electrical configuration of a pixel of the electrophoretic display device according to the fifth embodiment.

FIG. 14 is an equivalent circuit diagram showing a first modified example of an electrophoretic display device according to the fifth embodiment.

FIG. 15 is an equivalent circuit diagram showing a second modified example of an electrophoretic display device according to the fifth embodiment.

FIG. 16 is a perspective view showing the configuration of an electronic paper sheet.

FIG. 17 is a perspective view showing the configuration of an electronic notebook.

### DESCRIPTION OF EXEMPLARY EMBODIMENTS

Hereinafter, embodiments of the invention will be described with reference to the accompanying drawings.

### First Embodiment

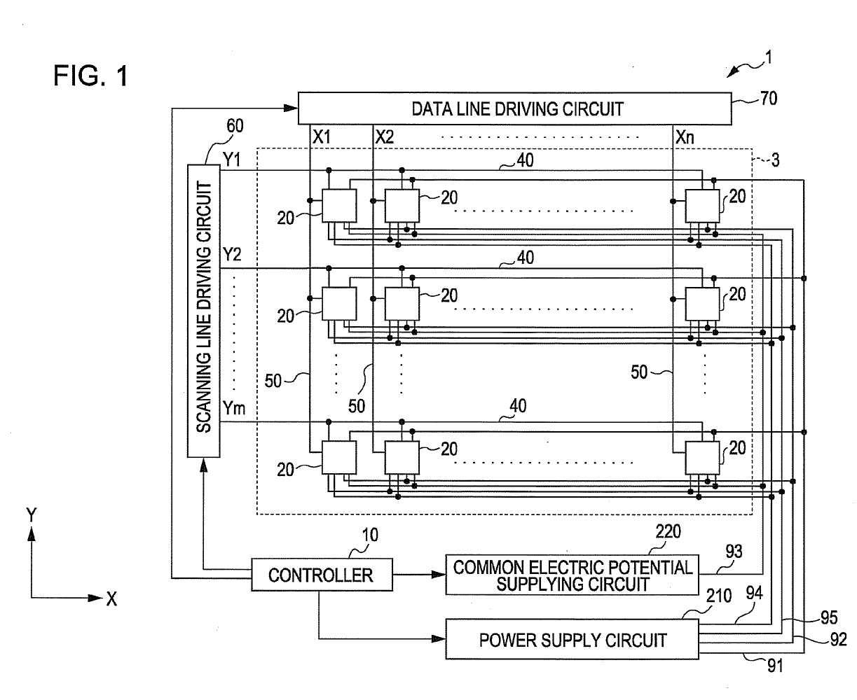

An electrophoretic display device according to a first embodiment of the invention will now be described with reference to FIGS. 1 to 4.

First, the whole configuration of the electrophoretic display device according to this embodiment will be described with reference to FIG. 1.

FIG. 1 is a block diagram showing the whole configuration of an electrophoretic display device according to a first embodiment of the invention.

As shown in FIG. 1, the electrophoretic display device 1 according to the first embodiment includes a display unit 3, a controller 10, a scanning line driving circuit 60, a data line driving circuit 70, a power supply circuit 210, and a common electric potential supplying circuit 220.

In the display unit 3, pixels 20 of m rows×n columns are arranged in a matrix shape (in a two-dimensional plane). In addition, in the display unit 3, m scanning lines 40 (that is, scanning lines Y1, Y2, . . . , Ym) and n data lines 50 (that is, data lines X1, X2, . . . , Xn) are disposed to intersect each other. In particular, m scanning lines 40 extend in the row direction (that is, direction X), and n data lines 50 extend in the column direction (that is, direction Y). In addition, the pixels 20 are disposed in correspondence with intersections of the m scanning lines 40 and the n data lines 50.

The controller 10 controls operations of the scanning line driving circuit 60, the data line driving circuit 70, the power supply circuit 210, and the common electric potential supplying circuit 220. Specifically, The controller 10, for example, supplies timing signals such as a clock signal and a start pulse to each circuit.

The scanning line driving circuit 60 sequentially supplies scanning signals in pulses to the scanning lines Y1, Y2, . . . , Ym based on a timing signal that is supplied from the controller 10.

The data line driving circuit 70 supplies image signals to the data lines X1, X2, . . . , Xn based on a timing signal that is supplied from the controller 10. The image signals have binary levels including a high electric potential level (hereinafter, referred to as a “high level”, for example, 5 V) and a low electric potential level (hereinafter, referred to as a low level, for example, 0 V).

The power supply circuit 210 supplies a high power supplying electric potential VEP to a high-electric potential power line 91, supplies a low power supplying electric potential Vss to a low-electric potential power line 92, supplies a first pixel electric potential S1 to a first control line 94, and supplies a second pixel electric potential S2 to a second control line 95. Although not shown in the figure, the high-electric potential power line 91, the low-electric potential power line 92, the first control line 94, and the second control line 95 are electrically connected to the power supply circuit 210 through electrical switches.

The common electric potential supplying circuit 220 supplies a common electric potential Vcom to a common electric potential line 93. Although not shown in the figure, the common electric potential line 93 is electrically connected to the common electric potential supplying circuit 220 through an electrical switch.

In addition, various signals are input to or output from the controller 10, the scanning line driving circuit 60, the data line driving circuit 70, the power supply circuit 210, and the common electric potential supplying circuit 220. However, a description for transmission of signals that is not directly related to this embodiment is omitted here.

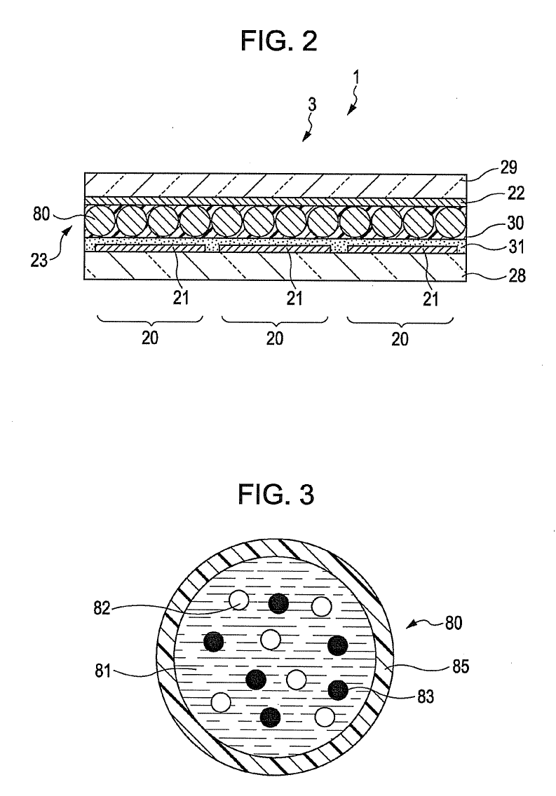

Next, a detailed configuration of the display unit of the electrophoretic display device according to this embodiment will be described with reference to FIGS. 2 and 3.

FIG. 2 is a partial cross-section view of the display unit of the electrophoretic display device according to this embodiment.

As shown in FIG. 2, the display unit 3 has a configuration in which the electrophoretic element 23 is pinched between a component substrate 28 and an opposing substrate 29. In this embodiment, descriptions will be made on a premise that an image is displayed on the opposing substrate 29 side.

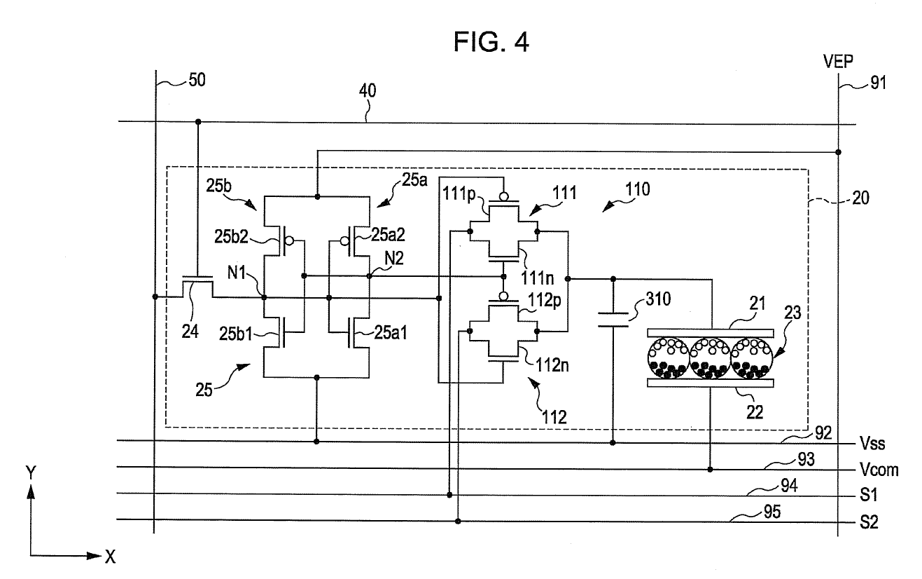

The component substrate 28 is an example of “one substrate” according to an embodiment of the invention and, for example, is formed of glass, plastic, or the like. On the component substrate 28, although not shown in the figure, a lamination structure in which the pixel switching transistor 24, the memory circuit 25, the switching circuit 110, the scanning lines 40, the data lines 50, the high electric potential power line 91, the low electric potential power line 92, the common electric potential line 93, the first control line 94, the second control line 95, and the like that will be described later are formed is formed (see FIG. 4). On the upper-layer side of the lamination structure, a plurality of the pixel electrodes 21 is disposed in a matrix shape.

The opposing substrate 29 is an example of the other substrate other than the “one substrate” of “one pair of substrates” according to an embodiment of the invention and is a transparent substrate, for example, formed of glass, plastic, or the like. On a face of the opposing substrate 29 which faces the component substrate 28, the common electrode 22 is formed on the entire face so as to face a plurality of pixel electrodes 9a. The common electrode 22 is formed of a transparent conduction material such as magnesium silver (MgAg), indium tin oxide (ITO), or indium zinc oxide (IZO).

The electrophoretic element 23 is configured by a plurality of the microcapsules 80 that is formed to include electrophoretic particles. The electrophoretic element 23 is fixed between the component substrate 28 and the opposing substrate 29 by a binder 30, for example, formed of a resin or the like and an adhesive layer 31. In the electrophoretic display device 1 according to this embodiment, in the manufacturing process, an electrophoretic sheet in which the electrophoretic element 23 is fixed to the opposing substrate 29 side by a binder 30 in advance is bonded to a side of the separately-produced component substrate 28 on which the pixel electrode 21 and the like are formed through the adhesive layer 31.

The microcapsule 80 is pinched by the pixel electrode 21 and the common electrode 22. One or a plurality of the microcapsules is disposed within one pixel 20 (that is, for one pixel electrode 21).

FIG. 3 is a schematic diagram showing the configuration of the microcapsule. In FIG. 3, the cross-section of the microcapsule is shown.

As shown in FIG. 3, inside a coating film 85 of the microcapsule 80, a dispersion medium 81, a plurality of white particles 82, and a plurality of black particles 83 are enclosed. The microcapsule 80, for example, is formed in a sphere shape having a particle diameter of about 50 μm. The white particles 82 and the black particles 83 are examples of the “electrophoretic element” according to an embodiment of the invention.

The coating film 85 serves as an outer shell of the microcapsule 80 and is formed of high-molecular resin such as acryl resin including polymethylmethacrylate, polyethylmethacrylate, or the like, urea resin, gum Arabic, or the like that has transparency.

The dispersion medium 81 is a medium that disperses the white particles 82 and the black particles 83 into the inside of the microcapsule 80 (that is, the inside of the coating film 85). As the dispersion medium 81, water; an alcohol-based solvent such as methanol, ethanol, isopropanol, butanol, octanol, or methyl cellosolve; a variety of esters such as acetic ethyl or acetic butyl; ketone such as acetone, methylethylketone, or methylisobutylketone; aliphatic hydrocarbon such as pentane, hexane, or octane; cycloaliphatic hydrocarbon such as cyclohexane or methylcyclohexane; aromatic hydrocarbon such as benzene, toluene, or benzene having a long-chain alkyl group including xylene, hexylbenzene, hebuthylbenzene, octylbenzene, nonylbenzene, decylbenzene, undecylbenzene, dodecylbenzene, tridecylebenzene, or tetradecylbenzene; halogenated hydrocarbon such as methylene chloride, chloroform, carbon tetrachloride, or 1,2-dichloroethane; carboxylate; or other kinds of oils can be used in the form of a single material or a mixture. In addition, surfactant may be added to the above-described dispersion medium 81.

The white particles 82 are particles (polymer particles or colloids) made of white pigment such as titanium dioxide, zinc flower (zinc oxide), or antimony trioxide and, for example, are charged negatively.

The black particles 83 are particles (polymer particles or colloids) made of black pigment such as aniline black or carbon black and, for example, are charged positively.

Accordingly, the white particles 82 and the black particles 83 can move in the dispersion medium 81 due to an electric field that is generated by an electric potential difference between the pixel electrode 21 and the common electrode 22.

In addition, a charge control agent containing particles of an electrolyte, a surfactant, metal soap, a resin, rubber, oil, varnish, compound, or the like; a dispersant such as a titanium-coupling agent, an aluminum-coupling agent, and a silane-coupling agent; a lubricant; a stabilizing agent; or the like may be added to the above-described pigment, as is needed.

In FIGS. 2 and 3, when a voltage is applied between the pixel electrode 21 and the common electrode 22 such that the electric potential of the common electrode 22 is high relative to the pixel electrode, the positively charged black particles 83 are attracted to the pixel electrode 21 side within the microcapsule 80 by the coulomb force, and the negatively charged white particles 82 are attracted to the common electrode 22 side within the microcapsule 80 by the coulomb force. As a result, the white particles 82 are collected on the display face side (that is, the common electrode 22 side) of the microcapsule 80, and thereby the color (that is, the white color) of the white particles 82 can be displayed on the display face of the display unit 3. To the contrary, when a voltage is applied between the pixel electrode 21 and the common electrode 22 such that the electric potential of the pixel electrode 21 is high relative to the common electrode, the negatively charged white particles 82 are attracted to the pixel electrode 21 side by the coulomb force, and the positively charged black particles 83 are attracted to the common electrode 22 side by the coulomb force. As a result, the black particles 83 are collected on the display face side of the microcapsule 80, and thereby the color (that is, the black color) of the black particles 83 can be displayed on the display face of the display unit 3.

In addition, by changing the state of the distribution of the white particles 82 and the black particles 83 between the pixel electrode 21 and the common electrode 22, a gray color such as a light gray color, a gray color, or a dark gray color that corresponds to an intermediate gray scale level between the white color and the black color can be displayed. For example, after the black particles 83 are collected on the display face side of the microcapsule 80 and the white particles 82 are collected on the pixel electrode 21 side by applying a voltage between the pixel electrode 21 and the common electrode 22 such that the electric potential of the pixel electrode 21 becomes high relative to that of the common electrode, a voltage is applied between the pixel electrode 21 and the common electrode 22 such that the electric potential of the common electrode 22 becomes high relative to that of the pixel electrode 22 only for a predetermined period corresponding to an intermediate gray scale level to be represented, and thereby a predetermined amount of the white particles 82 are moved to the display face side of the microcapsule 80 and a predetermined amount of the black particles 83 are moved to the pixel electrode 21 side. As a result, a gray color that corresponds to an intermediate gray scale level between the white color and the black color can be displayed on the display face of the display unit 3.

In addition, by using pigment, for example, of a red color, a green color, a blue color, or the like instead of the pigment used for the white particles 82 or the black particles 83, the red color, the green color, the blue color, or the like can be displayed.

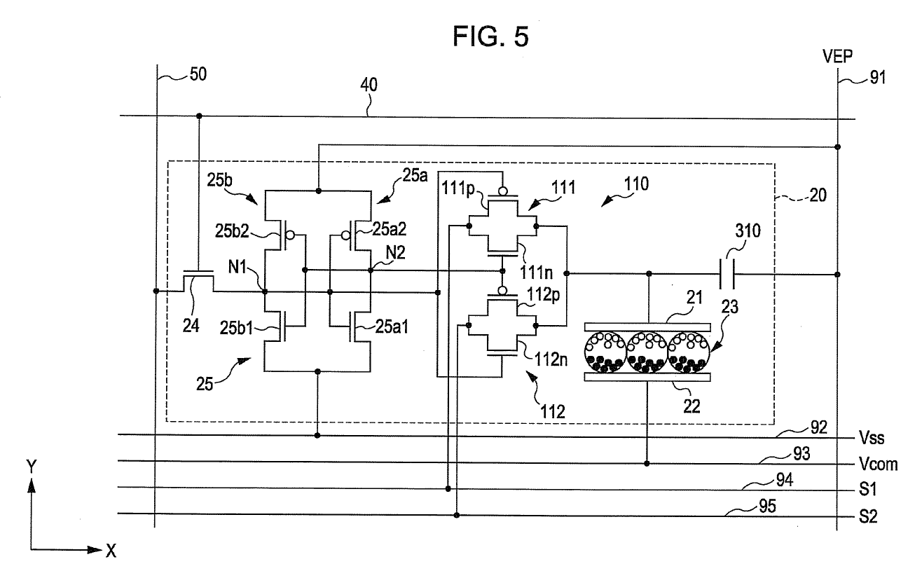

Next, a detailed circuit configuration of the pixel unit of the electrophoretic display device according to this embodiment will be described with reference to FIGS. 4 and 5.

FIG. 4 is an equivalent circuit diagram showing the electrical configuration of a pixel of the electrophoretic display device according to the first embodiment.

As shown in FIG. 4, the pixel 20 includes a pixel switching transistor 24, a memory circuit 25, a switching circuit 110, a pixel electrode 21, a common electrode 22, an electrophoretic element 23, and a capacitor 310.

The pixel switching transistor 24 is an example of the “pixel switching element” according to an embodiment of the invention and is configured by an N-type transistor. The gate of the pixel switching transistor 24 is electrically connected to the scanning line 40, the source of the pixel switching transistor is electrically connected to the data line 50, and the drain of the pixel switching transistor is electrically connected to an input terminal N1 of the memory circuit 25. The pixel switching transistor 24 outputs an image signal that is supplied from the data line driving circuit 70 (see FIG. 1) through the data line 50 to the input terminal N1 of the memory circuit 25 at a timing corresponding to the scanning signal that is supplied as a pulse from the scanning line driving circuit 60 (see FIG. 1) through the scanning line 40.

The memory circuit 25 includes inverter circuits 25a and 25b and is configured by an SRAM.

The inverter circuits 25a and 25b form a loop structure in which, to an input terminal of any one between the inverter circuits, an output terminal of the other is connected. In other words, the input terminal of the inverter circuit 25a and the output terminal of the inverter circuit 25b are electrically connected together, and the input terminal of the inverter circuit 25b and the output terminal of the inverter circuit 25a are electrically connected together. In addition, the input terminal of the inverter circuit 25a is configured as the input terminal N1 of the memory circuit 25, and the output terminal of the inverter circuit 25a is configured as an output terminal N2 of the memory circuit 25.

The inverter circuit 25a has an N-type transistor 25a1 and a P-type transistor 25a2. The gates of the N-type transistor 25a1 and the P-type transistor 25a2 are electrically connected to the input terminal N1 of the memory circuit 25. The source of the N-type transistor 25a1 is electrically connected to the low electric potential power line 92 to which the low power supplying electric potential Vss is supplied. In addition, the source of the P-type transistor 25a2 is electrically connected to the high electric potential power line 91 to which the high power supplying electric potential VEP is supplied. The drains of the N-type transistor 25a1 and the P-type transistor 25a2 are electrically connected to the output terminal N2 of the memory circuit 25.

The inverter circuit 25b has an N-type transistor 25b1 and a P-type transistor 25b2. The gates of the N-type transistor 25b1 and the P-type transistor 25b2 are electrically connected to the output terminal N2 of the memory circuit 25. The source of the N-type transistor 25b1 is electrically connected to the low electric potential power line 92 to which the low power supplying electric potential Vss is supplied. In addition, the source of the P-type transistor 25b2 is electrically connected to the high electric potential power line 91 to which the high power supplying electric potential VEP is supplied. The drains of the N-type transistor 25b1 and the P-type transistor 25b2 are electrically connected to the input terminal N1 of the memory circuit 25.

The memory circuit 25 outputs the low power supplying electric potential Vss from the output terminal N2 in a case where a high-level image signal is input to the input terminal N1 and outputs the high power supplying electric potential VEP from the output terminal N2 in a case where a low-level image signal is input to the input terminal N1. In other words, the memory circuit 25 outputs the low power supplying electric potential Vss or the high power supplying electric potential VEP depending on whether the input image signal is the high level or the low level. It may be paraphrased that the memory circuit 25 is configured to be able to store the input image signal as the low power supplying electric potential Vss or the high power supplying electric potential VEP.

The high electric potential power line 91 and the low electric potential power line 92 are configured to be supplied with the high power supplying electric potential VEP and the low power supplying electric potential Vss from the power supply circuit 210. The high electric potential power line 91 and the low electric potential line 92 are electrically connected to the power supply circuit 210 through switches not shown in the figure. As each switch is in the ON state, the high electric potential power line 91 and the low electric potential power line 92 and the power supply circuit 210 are electrically connected together. On the other hand, as each switch is in the OFF state, the high electric potential power line 91 and the low electric potential power line 92 is in a high-impedance state to be electrically cut off.

The switching circuit 110 includes a first transmission gate 111 and a second transmission gate 112.

The first transmission gate 111 has a P-type transistor 111p and an N-type transistor 111n. The sources of the P-type transistor 111p and the N-type transistor 111n are electrically connected to the first control line 94. In addition, the drains of the P-type transistor 111p and the N-type transistor 111n are electrically connected to a pixel electrode 21. The gate of the P-type transistor 111p is electrically connected to the input terminal N1 of the memory circuit 25, and the gate of the N-type transistor 111n is electrically connected to the output terminal N2 of the memory circuit 25.

The second transmission gate 112 has a P-type transistor 112p and an N-type transistor 112n. The sources of the P-type transistor 112p and the N-type transistor 112n are electrically connected to the second control line 95. In addition, the drains of the P-type transistor 112p and the N-type transistor 112n are electrically connected to the pixel electrode 21. The gate of the P-type transistor 112p is electrically connected to the output terminal N2 of the memory circuit 25, and the gate of the N-type transistor 112n is electrically connected to the input terminal N1 of the memory circuit 25.

The switching circuit 110 alternately selects any one control line between the first control line 94 and the second control line 95 in accordance with an image signal input to the memory circuit 25 and electrically connects the one control line to the pixel electrode 21.

In particular, when an image signal having a high level is input to the input terminal N1 of the memory circuit 25, the low power supplying electric potential Vss is output from the memory circuit 25 to the gates of the N-type transistor 111n and the P-type transistor 112p, and the high power supplying electric potential VEP is output to the gates of the P-type transistor 111p and the N-type transistor 112n. Accordingly, in such a case, only the P-type transistor 112p and the N-type transistor 112n that constitute the second transmission gate 112 are in the ON state, and the P-type transistor 111p and the N-type transistor 111n that constitute the first transmission gate 111 are in the OFF state. On the other hand, when an image signal having a low level is input to the input terminal N1 of the memory circuit 25, the high power supplying electric potential VEP is output from the memory circuit 25 to the gates of the N-type transistor 111n and the P-type transistor 112p, and the low power supplying electric potential Vss is output to the gates of the P-type transistor 111p and the N-type transistor 112n. Accordingly, in such a case, only the P-type transistor 111p and the N-type transistor 111n that constitute the first transmission gate 111 are in the ON state, and the P-type transistor 112p and the N-type transistor 112n that constitute the second transmission gate 112 are in the OFF state. In other words, when an image signal having the high level is input to the input terminal N1 of the memory circuit 25, only the second transmission gate 112 is in the ON state. On the other hand, when an image signal having the low level is input to the input terminal N1 of the memory circuit 25, only the first transmission gate 111 is in the ON state.

The first control line 94 and the second control line 95 are configured to be supplied with the first pixel electric potential S1 and the second pixel electric potential S2 from the power supply circuit 210. The first control line 94 and the second control line 95 are electrically connected to the power supply circuit 210 through switches not shown in the figure. As each switch is in the ON state, the first control line 94 or the second control line 95 is electrically connected to the power supply circuit 210. On the other hand, as each switch is in the OFF state, the first control line 94 or the second control line 95 is in the high-impedance state to be electrically cut off.

A pixel electrode 21 of each of the plurality of the pixels 20 is electrically connected to the control line 94 or 95 that is alternately selected in accordance with the image signal by the switching circuit 110. In such a case, the pixel electrode 21 of each of the plurality of the pixels 20 is supplied with the first electric potential S1 or the second electric potential S2 from the power supply circuit 210 based on the ON state or OFF state of the switch that is disposed between the first control line 94 and the second control line 95 and the power supply circuit 210 or is in the high-impedance state.

In particular, in the pixel 20 to which the image signal having the low level is supplied, only the first transmission gate 111 is in the ON state. Accordingly, the pixel electrode 21 of the pixel 20 is electrically connected to the first control line 94 and is supplied with the first pixel electric potential S1 from the power supply circuit 210 or is in the high-impedance state in accordance with the ON state or the OFF state of the switch. On the other hand, in the pixel 20 to which the image signal having the high level is supplied, only the second transmission gate 112 is in the ON state. Accordingly, the pixel electrode 21 of the pixel 20 is electrically connected to the second control line 95 and is supplied with the second pixel electric potential S2 from the power supply circuit 210 or is in the high-impedance state in accordance with the ON or OFF state of the switch.

The pixel electrode 21 is disposed to face the common electrode 22 through the electrophoretic element 23.

The common electrode 22 is electrically connected to the common electric potential line 93 to which the common electric potential Vcom is supplied. The common electric potential line 93 is configured to be able to be supplied with the common electric potential Vcom from the common electric potential supplying circuit 220. The common electric potential line 93 is electrically connected to the common electric potential supplying circuit 220 through a switch(not shown). As the switch is in the ON state, the common electric potential supplying circuit 220 is electrically connected to the common electric potential line 93. In addition, as the switch is in the OFF state, the common electric potential line 93 is in the high-impedance state to be electrically cut off.

As described above, the electrophoretic element 23 is configured by a plurality of the microcapsules 80 that is formed to include electrophoretic particles 82 and 83.

A capacitor 310 is an example of a “capacitor element (a first capacitor element) that is included in an “electrostatic protection unit” according to an embodiment of the invention. The capacitor 310 is formed between a wiring that electrically connects the pixel electrode 21 and the switching circuit 110 and the low electric potential power line 92 that is an example of a “holding electric potential supplying line” according to an embodiment of the invention which supplies the low power supplying electric potential Vss. For example, the capacitor 310 is formed by forming a capacitor electrode layer that is disposed to face the wiring electrically connecting the pixel electrode 21 and the switching circuit 110 through a capacitor insulating film and electrically connecting the capacitor electrode layer to the low electric potential power line 92 through a contact hole or the like. Here, the wiring that electrically connects the pixel electrode 21 and the switching circuit 110 is an example of “one capacitor electrode” according to an embodiment of the invention, and the capacitor insulating film is an example of a “dielectric film” according to an embodiment of the invention, and the capacitor electrode layer is an example of “another capacitor electrode”. It is preferable that the capacitor electrode has a relatively large area for acquiring sufficient capacity.

The capacitor 310, particularly, prevents damage of the switching circuit 110 due to electrostatic discharge in the process of manufacturing the electrophoretic display device according to this embodiment. In particular, for example, applying an extremely high voltage to the switching circuit 110, which is caused by static electricity of the pixel electrode 21, so as to incur damages due to electrostatic discharge of the N-type transistors 111n and 112n and the P-type transistors 111p and 112p that configure the switching circuit 110 due to the electrostatic discharge can be prevented.

Here, it is assumed that an electric charge amount Q is generated in the pixel electrode 21 due to static electricity. In such a case, when the capacitance of the capacitor is denoted by C, the voltage V applied to the switching circuit 110 is V=Q/C. Accordingly, by adding the capacitance C by using the capacitor 310, the voltage V applied to the switching circuit 110 is decreased. The capacitance C of the capacitor may be set such that the voltage V applied to the switching circuit 110 does not exceed breakdown voltages of the elements. Typically, it is preferable that the capacitance C of the capacitor has a value that is equal to or larger than the order of pF (pico Farad).

When the electrophoretic display device according to this embodiment is driven, the capacitor 310 is charged and discharged in accordance with the voltage applied to the pixel electrode 21 and the low power supplying electric potential Vss. However, there is a scarcely or no bad influence on an image displayed in the display unit 3 (see FIG. 1).

FIG. 5 is an equivalent circuit diagram showing a first modified example of the electrophoretic display device according to the first embodiment.

As shown in FIG. 5, the capacitor 310 may be configured to be electrically connected to the high electric potential power line 91, which outputs a high power supplying electric potential VEP, instead of the low electric potential power line 92. In other words, the capacitor 310 may be configured to use the high electric potential power line 91 as the “holding electric potential supplying line”. Even in such a case, same as shown in FIG. 4, damages due to electrostatic discharge can be prevented by decreasing the voltage applied to the switching circuit 110.

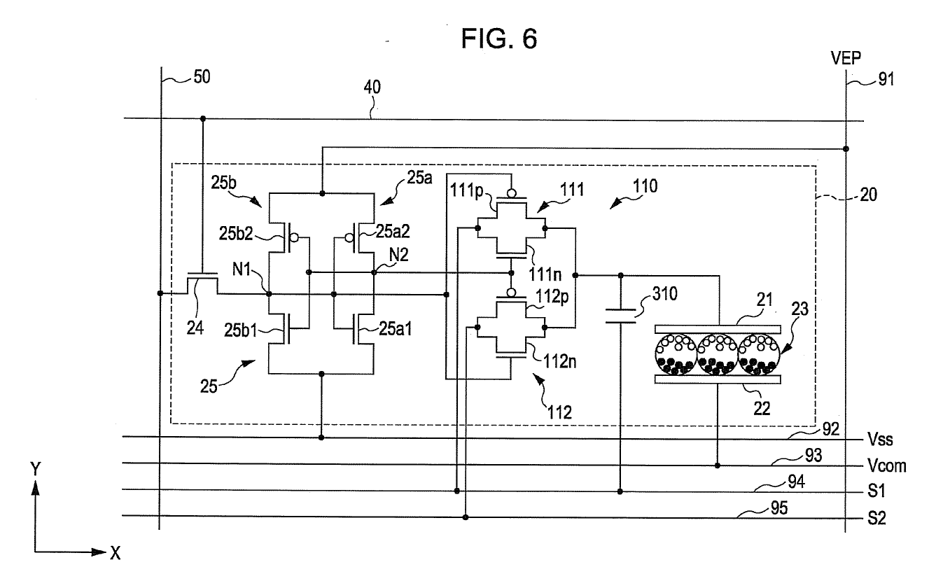

FIG. 6 is an equivalent circuit diagram showing a second modified example of the electrophoretic display device according to the first embodiment.

As shown in FIG. 6, the capacitor 310 may be configured to be electrically connected to the first control line 94 instead of the low electric potential power line 92. In addition, although not shown here, the capacitor 310 may be configured to be electrically connected to the second control line 95. The capacitor 310 that is electrically connected to the first control line 94 or the second control line 95 corresponds to a “second capacitor element” according to an embodiment of the invention. Even in such a case, as shown in FIG. 4, damages due to electrostatic discharge can be prevented by decreasing the voltage applied to the switching circuit 110.

To the wiring that electrically connects the pixel electrode 21 and the switching circuit 110, the first pixel electric potential S1 and the second pixel electric potential S2 are applied through the switching circuit 110 at the time of driving the device. In other words, a same voltage is applied to the first control lint 94 and the second control line 95. Thus, as described above, when the capacitor 310 is electrically connected to the first control line 94 or the second control line 95, there is a high possibility that a same voltage is applied to both ends of the capacitor 310. In such a case, the capacitor 310 is not charged. Accordingly, power consumption at the time of driving the device can be reduced.

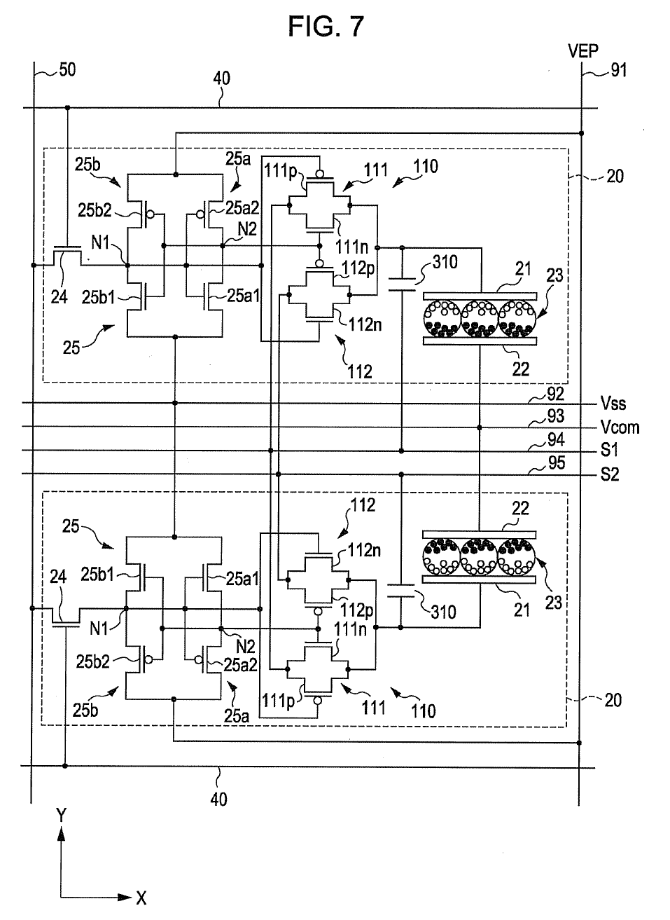

FIG. 7 is an equivalent circuit diagram showing a third modified example of the electrophoretic display device according to the first embodiment.

As shown in FIG. 7, the high-electric potential power line 91, the low-electric potential power line 92, the common electric potential line 93, the first control line 94, and the second control line 95 may be shared by pixels 20 that are adjacent in direction Y. In such a case, when the capacitor 310 of one pixel between the adjacent pixels 20 is electrically connected to the first control line 94, and the capacitor 310 of the other pixel is electrically connected to the second control line 95, the advantage that the power consumption is reduced can be acquired without any bias (that is, at a same degree for cases where the first pixel electric potential S1 is supplied to the pixel electrode and the second pixel electric potential S2 is supplied to the pixel electrode). In other words, by configuring the number of pixels in which each capacitor 310 is connected to the first control line 94 and the number of pixels in which each capacitor 310 is connected to the second control line 95 to be the same or almost the same, the power consumption can be reduced much more appropriately.

As described above, according to the electrophoretic display device of the first embodiment, the capacitor 310 is disposed, and accordingly, the damage of the switching circuit 110 due to electrostatic discharge at the time of manufacture can be prevented effectively. In addition, an end portion of the capacitor 310 located on a side opposite to an end portion thereof that is electrically connected to the pixel electrode 21 may be connected to a wiring other than the above-described wiring. In other words, when the voltage applied to the switching circuit 110 can be reduced within a range in which there is no bad influence on display of an image at the time of driving the device, the capacitor 310 may be connected to any wiring in the circuit. In addition, a configuration in which a plurality of capacitors 310 is disposed for one pixel electrode 21 for acquiring the capacitance may be used.

### Second Embodiment

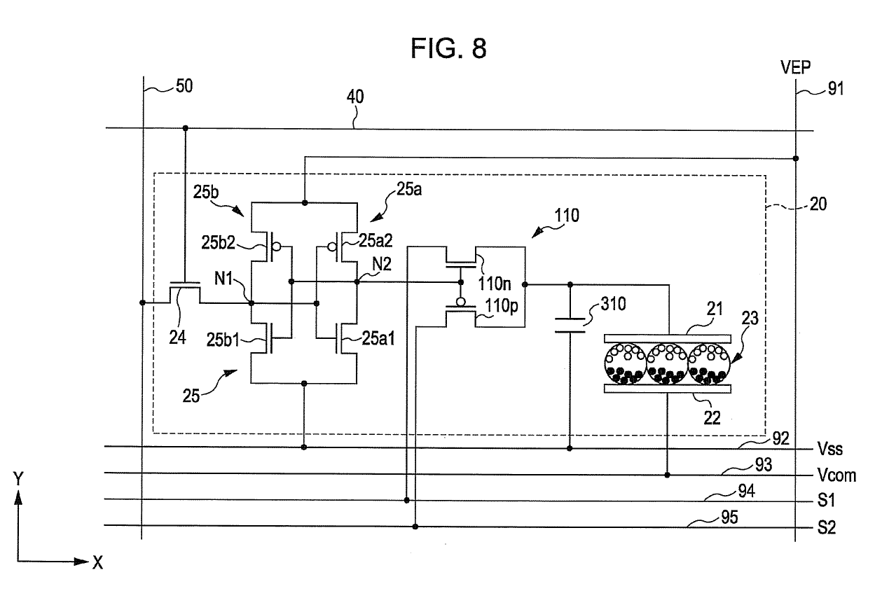

A method of driving an electrophoretic display device according to a second embodiment of the invention will be described with reference to FIG. 8. According to the second embodiment, the circuit configuration of each pixel is different from that according to the first embodiment. Other configurations of the second embodiment are the same as those of the first embodiment on the whole. Thus, in the second embodiment, a part that is different from that of the first embodiment will be described in detail, and description of the configuration of the other parts will be omitted appropriately.

FIG. 8 is an equivalent circuit diagram showing the electrical configuration of a pixel of the electrophoretic display device according to the second embodiment. In FIG. 8, to each constituent element that is the same as that of the first embodiment shown in FIG. 2, a same reference sign is assigned.

As shown in FIG. 8, a pixel 20 of the electrophoretic display device according to the second embodiment includes a pixel switching transistor 24, a memory circuit 25, a pixel electrode 21, a common electrode 22, an electrophoretic element 23, a switching circuit 110, and a capacitor 310.

The switch circuit 110 has a P-type transistor 110p and an N-type transistor 110n. In other words, the switching circuit 110 of the electrophoretic display device according to the second embodiment has fewer transistors than the switching circuit 110 according to the first embodiment.

The gate of the P-type transistor 110p is electrically connected to the output terminal N2 of the memory circuit 25. In addition, the source of the P-type transistor 110p is electrically connected to the second control line 95, and the drain of the P-type transistor 110p is electrically connected to the pixel electrode 21. The gate of the N-type transistor 110n is electrically connected to the output terminal N2 of the memory circuit 25. In addition, the source of the N-type transistor 100n is electrically connected to the first control line 94, and the drain of the N-type transistor 110n is electrically connected to the pixel electrode 21.

The switching circuit 110 alternately selects any one control line between the first control line 94 and the second control line 95 in accordance with an image signal input to the memory circuit 25 and electrically connects the one control line to the pixel electrode 21.

The capacitor 310 is formed between a wiring that electrically connects the pixel electrode 21 and the switching circuit 110 and a low-electric potential power line 92 that supplies a low power supplying electric potential Vss. The capacitor 310, same as in the first embodiment, prevents the damage of the switching circuit 110 due to electrostatic discharge in the manufacturing process of the electrophoretic display device. In particular, for example, applying an extremely high voltage to the switching circuit 110, which is caused by static electricity in the pixel electrode 21, so as to incur damages due to electrostatic discharge of a P-type transistor 110p and an N-type transistor 110n that configure the switching circuit 110 due to electrostatic discharge can be prevented.

As described above, according to the electrophoretic display device of the second embodiment, the capacitor 310 is disposed, and accordingly, a damage of the switching circuit 110 due to electrostatic discharge at the time of manufacture can be prevented effectively.

### Third Embodiment

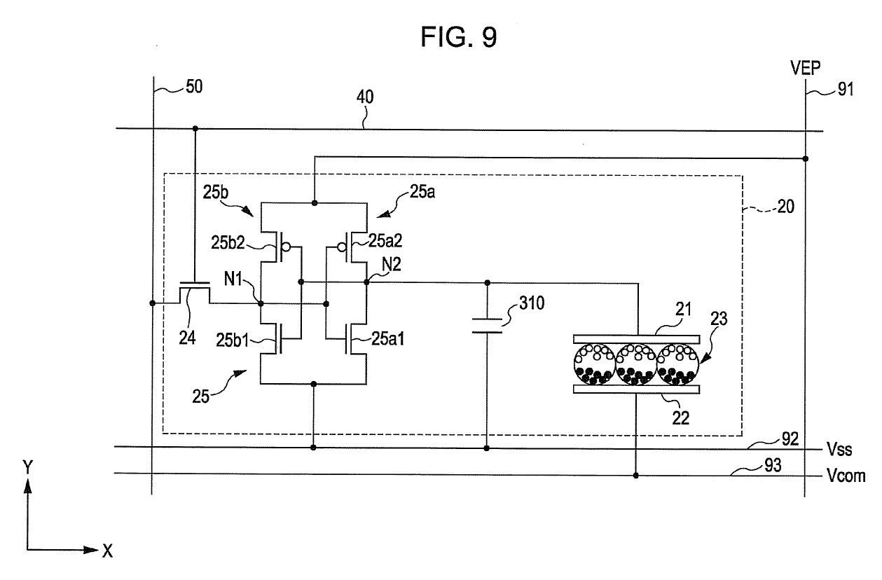

Next, A method of driving an electrophoretic display device according to a third embodiment of the invention will be described with reference to FIG. 9. According to the third embodiment, the circuit configuration of each pixel is different from those according to the first and second embodiments. Other configurations of the third embodiment are the same as those of the first and second embodiments on the whole. Thus, in the third embodiment, a part that is different from that of the first and second embodiments will be described in detail, and description of the configuration of the other parts will be omitted appropriately.

FIG. 9 is an equivalent circuit diagram showing the electrical configuration of a pixel of the electrophoretic display device according to the third embodiment. In FIG. 9, to each constituent element that is the same as that of the first embodiment shown in FIG. 2, a same reference sign is assigned.

As shown in FIG. 9, a pixel 20 of the electrophoretic display device according to the third embodiment includes a pixel switching transistor 24, a memory circuit 25, a pixel electrode 21, a common electrode 22, an electrophoretic element 23, and a capacitor 310. In other words, the electrophoretic display device according to the third embodiment, unlike the electrophoretic display devices according to the first and second embodiments, does not include the switching circuit 110, and the output from the memory circuit 25 is directly supplied to the pixel electrode 21.

The capacitor 310 is formed between a wiring that electrically connects the pixel electrode 21 and the memory circuit 25 and a low-electric potential power line 92 that supplies a low power supplying electric potential Vss. Here, the low-electric potential power line 92 is an example of a “holding electric potential supplying line” according to an embodiment of the invention.

The capacitor 310, prevents the damage of the memory circuit 25 due to electrostatic discharge particularly in the manufacturing process of the electrophoretic display device according to this embodiment. In particular, for example, applying an extremely high voltage to the memory circuit 25, which is caused by static electricity in the pixel electrode 21, so as to incur damages due to electrostatic discharge of transistors 25a1, 25a2, 25b1, and 25b2 that configure the memory circuit 25 due to electrostatic discharge can be prevented.

As described above, according to the electrophoretic display device of the third embodiment, the capacitor 310 is disposed, and accordingly, a damage of the memory circuit 25 due to electrostatic discharge at the time of manufacture can be prevented effectively.

### Fourth Embodiment

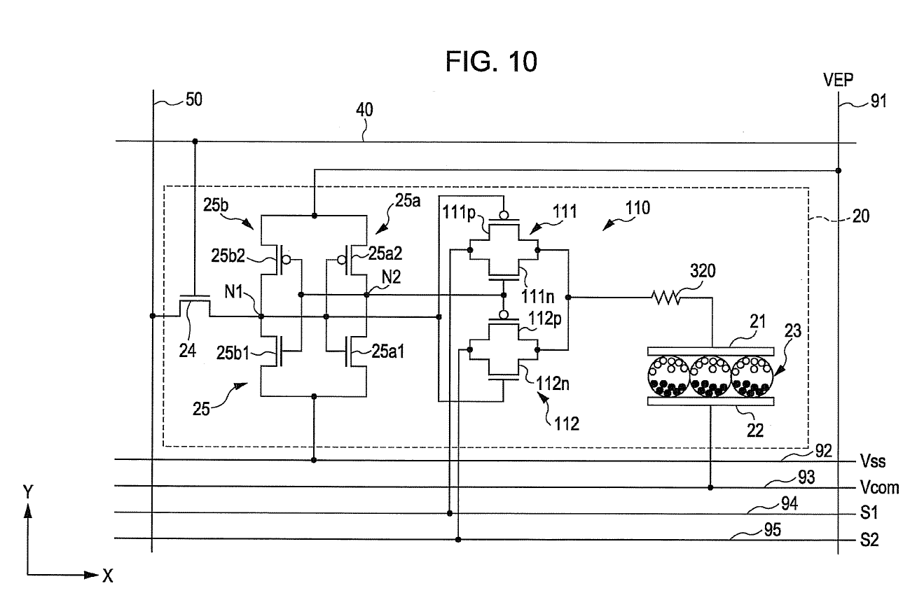

Next, a method of driving the electrophoretic display device according to the fourth embodiment will be described with reference to FIGS. 10 to 12. According to the fourth embodiment, an element that is disposed for electrostatic protection is different from that according to the first embodiment. Other configurations of the fourth embodiment are the same as those of the first embodiment on the whole. Thus, in the fourth embodiment, a part that is different from that of the first embodiment will be described in detail, and description of the configuration of the other parts will be omitted appropriately. In the embodiments hereinafter, same as the electrophoretic display device according to the first embodiment, an electrophoretic display device having a switching circuit 110 that is configured by four transistors will be described. However, the same configuration may be employed in the electrophoretic display devices according to the second and third embodiments.

FIG. 10 is an equivalent circuit diagram showing the electrical configuration of a pixel of the electrophoretic display device according to the fourth embodiment. In FIG. 10, to each constituent element that is the same as that of the first embodiment shown in FIG. 2, a same reference sign is assigned. In addition, the same applies to drawings thereafter.

As shown in FIG. 10, a pixel 20 of the electrophoretic display device according to the fourth embodiment includes a pixel switching transistor 24, a memory circuit 25, a pixel electrode 21, a common electrode 22, an electrophoretic element 23, and a resistor element 320. In other words, the electrophoretic display device according to the fourth embodiment includes the resistor element 320, instead of the capacitor 310 of the electrophoretic display device according to the first embodiment.

The resistor element 320 is disposed in a wiring that electrically connects the pixel electrode 21 and the switching circuit 110. The resistor element 320, particularly, same as the capacitor 310 in the electrophoretic display device according to the first embodiment, prevents a damage of the switching circuit 110 due to electrostatic discharge in the manufacturing process of the device.

In particular, by decreasing a current that flows from the pixel electrode 21 to the switching circuit 110 due to static electricity, the resistor element 320 prevents damages of N-type transistors 111n and 112n and P-type transistors 111p and 112p, which configure the switching circuit 110, due to electrostatic discharge. Accordingly, it is preferable that the resistance value of the resistor element 320 is a value for decreasing the current so as not to apply a voltage exceeding a breakdown voltage (that is, a voltage at which a damage due to electrostatic discharge can be generated) to the switching circuit 110. In a case where the resistor element 320 is formed of a Si thin film, when a high voltage is applied to the resistor element 320, the resistor element is melted down by the heat energy like a fuse. Accordingly, an increase in the electric potential also can be suppressed.

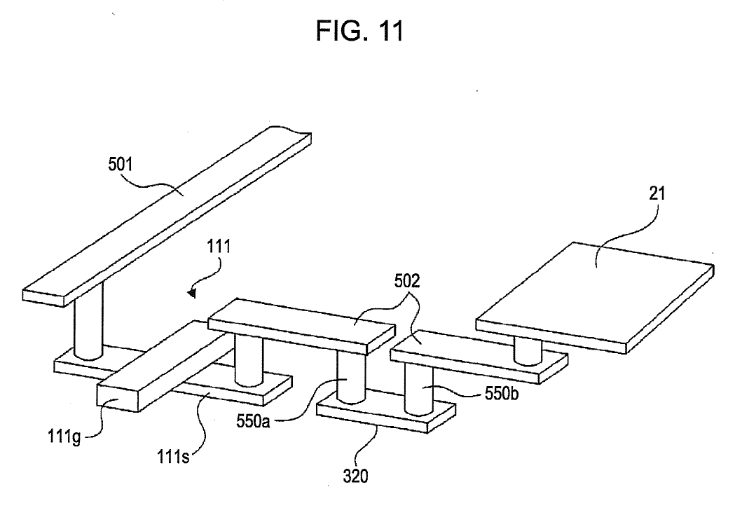

FIG. 11 is a perspective view showing the conceptual connection configuration of the pixel electrode, the resistor element, and the transistor configuring the switching circuit.

As shown in FIG. 11, the above-described resistor element 320 is disposed between 501 that, for example, supplies an output electric potential of the memory circuit 25 and a connection wiring 502 that electrically connects the transistor 111n configured to include a gate 111g and a semiconductor layer 111s and the pixel electrode 21. The resistor element 320 is electrically connected to the connection wiring 502 through contacts 550a and 550b. The resistor element 320 may not be formed as a separate body as shown in the figure, and the resistor element 320 may be configured by forming the connection wiring 502 or the pixel electrode 21 of a high-resistance material or may be added by covering the pixel electrode 21 with a high-resistance cover.

In addition, as shown in the figure, when the resistor element 320 is formed of a same thin film (that is, a film formed by a same film-forming process) as the semiconductor layer 111s configuring the transistor 111n, the complexity of the manufacturing process and the configuration of the device can be prevented.

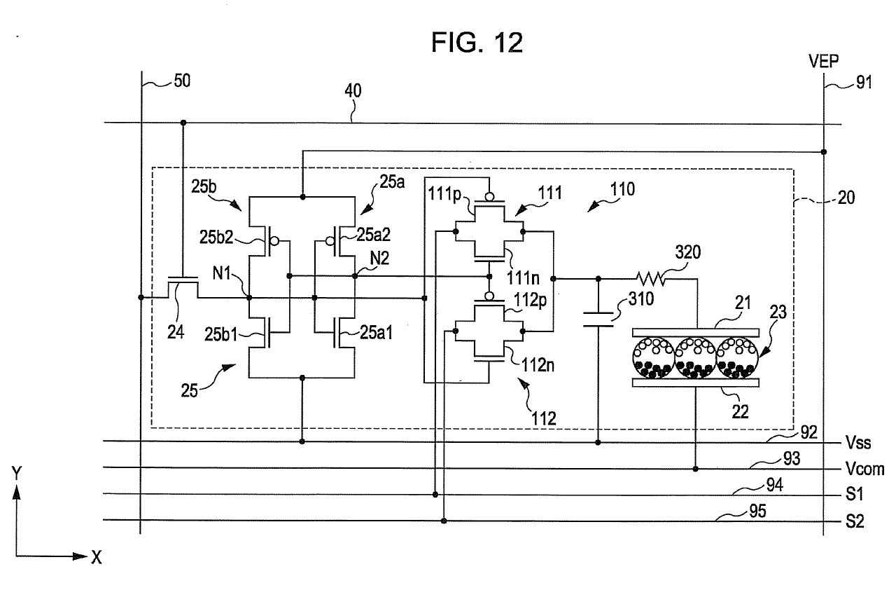

FIG. 12 is an equivalent circuit diagram showing a modified example of the electrophoretic display device according to the fourth embodiment.

As shown in FIG. 12, the electrophoretic display device according to the fourth embodiment may be configured to include a capacitor 310 in addition to the resistor element 320. In such a case, the voltage applied to the switching circuit 110 is decreased by both the resistor element 320 and the capacitor 310, and accordingly, a damage of the switching circuit 110 due to electrostatic discharge can be prevented more effectively.

When the capacitor 310 and the resistor element 320 are used together, as shown in the figure, by disposing the resistor element 320 on a side close to the pixel electrode 21 relative to the capacitor 310, a damage due to electrostatic discharge can be prevented more appropriately.

As described above, according to the electrophoretic display device of the fourth embodiment, the resistor element 320 is disposed, and accordingly, a damage of the switching circuit 110 due to electrostatic discharge at the time of manufacture can be prevented effectively.

### Fifth Embodiment

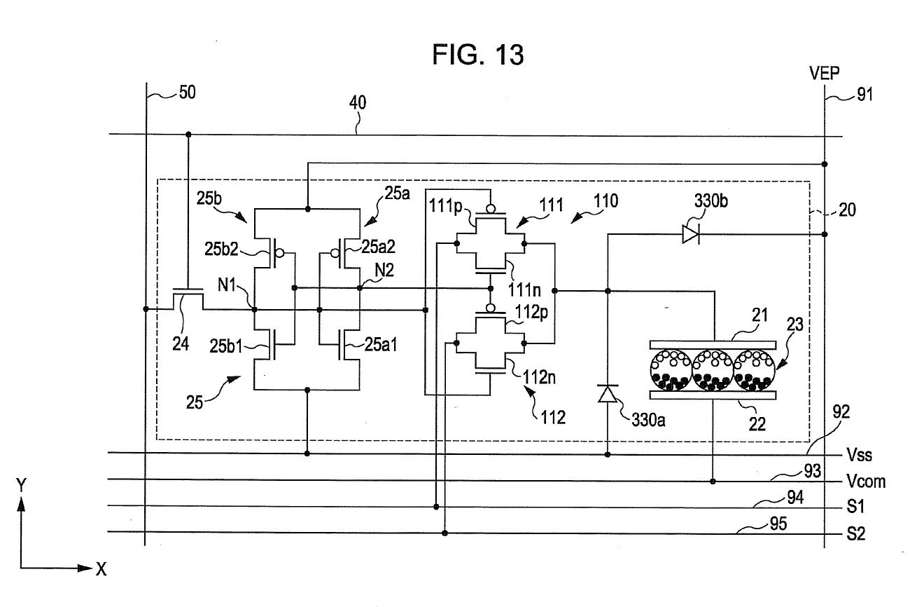

Next, an electrophoretic display device according to a fifth embodiment of the invention will now be described with reference to FIGS. 13 to 15. According to the fifth embodiment, an element that is disposed for electrostatic protection is different from those according to the first and fourth embodiments. Other configurations of the fifth embodiment are the same as those of the first and fourth embodiments on the whole. Thus, in the fifth embodiment, a part that is different from those of the first and fourth embodiments will be described in detail, and description of the configuration of the other parts will be omitted appropriately.

FIG. 13 is an equivalent circuit diagram showing the electrical configuration of a pixel of the electrophoretic display device according to the fifth embodiment. In FIG. 13, to each constituent element that is the same as that of the first embodiment shown in FIG. 2, a same reference sign is assigned. In addition, the same applies to drawings thereafter.

As shown in FIG. 13, a pixel 20 of the electrophoretic display device according to the fifth embodiment includes a pixel switching transistor 24, a memory circuit 25, a pixel electrode 21, a common electrode 22, an electrophoretic element 23, and diodes 330a and 330b. In other words, the electrophoretic display device according to the fifth embodiment includes two diodes 330a and 330b instead of the capacitor 310 of the electrophoretic display device according to the first embodiment and the resistor element 320 of the electrophoretic display device according to the fourth embodiment.

The diode 330a is formed between a wiring that electrically connects the pixel electrode 21 and the switching circuit 110 and the low electric potential power line 92 that supplies the low power supplying electric potential Vss. The diode 330a has a rectification action that allows a current to flow only to the pixel electrode 21 side. The diode 330b is formed between a wiring that electrically connects the pixel electrode 21 and the switching circuit 110 and the high electric potential power line 91 that supplies the high potential power supplying electric potential VEP. The diode 330b has a rectification action that allows a current to flow only from the pixel electrode 21 side.

The diodes 330a and 330b, similar to the capacitor 310 in the first embodiment, can decrease the voltage applied to the switching circuit 110. The diodes 330a and 330b may be connected to any wiring in the circuit within a range in which there is no bad influence on the display of an image at the time of driving the device. It is preferable that two diodes 330a and 330b have rectification functions for directions opposite to each other.

The diodes 330a and 330b, similar to the capacitor 310 in the first embodiment and the resistor element 320 in the fourth embodiment, prevents a damage of the switching circuit 110 due to electrostatic discharge in the manufacturing process of the device. In particular, by allowing a current, which flows from the pixel electrode 21 to the switching circuit 110 due to static electricity, to flow out to another wiring, the diodes 330a and 330b prevent damages of N-type transistors 111n and 112n and P-type transistors 111p and 112p, which configure the switching circuit 110, due to electrostatic discharge.

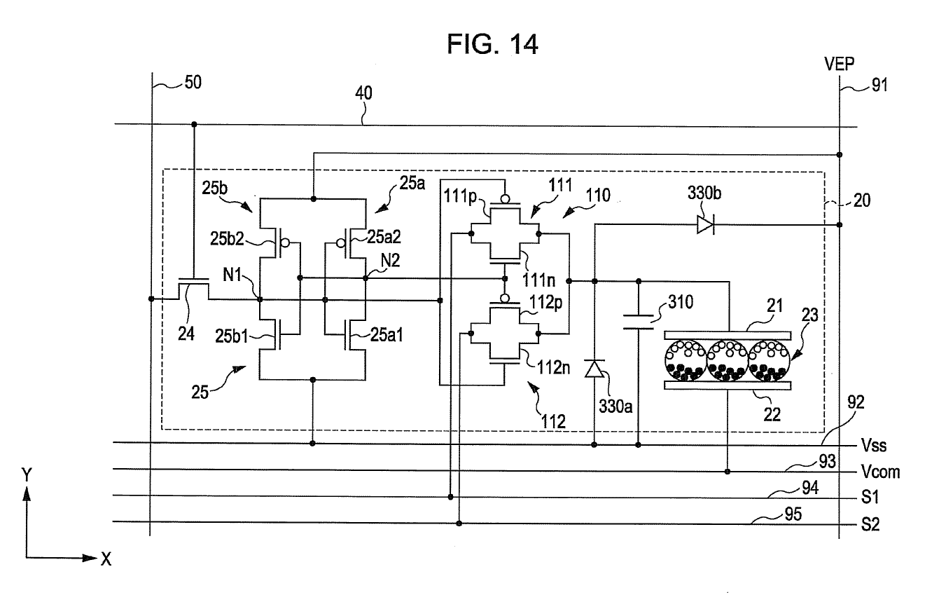

FIG. 14 is an equivalent circuit diagram showing a first modified example of an electrophoretic display device according to the fifth embodiment.

As shown in FIG. 14, in the electrophoretic display device according to the fifth embodiment, the capacitor 310 may be disposed, in addition to the diodes 330a and 330b. In such a case, a current caused by the static electricity is allowed to flow out to another wiring by the diodes 330a and 330b while being used for charging the capacitor 310. Accordingly, a damage of the switching circuit 110 due to electrostatic discharge can be prevented more effectively.

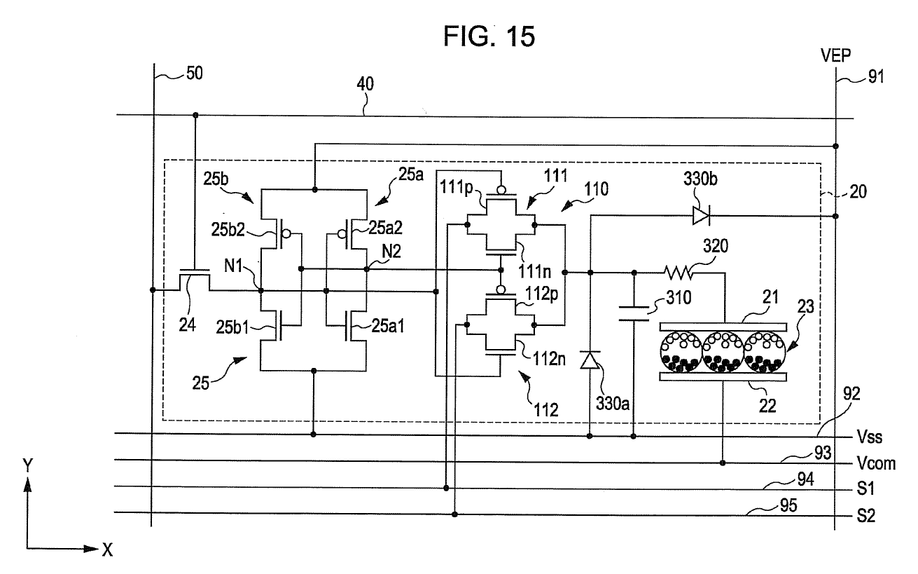

FIG. 15 is an equivalent circuit diagram showing a second modified example of an electrophoretic display device according to the fifth embodiment.

As shown in FIG. 15, in the electrophoretic display device according to the fifth embodiment, the resistor element 320 may be disposed, in addition to the diodes 330a and 330b and the capacitor 310. In such a case, it is possible to decrease the current caused by static electricity by using three types of elements including the diode 330, the capacitor 310, and the resistor element 320. Accordingly, a damage of the switching circuit 110 due to electrostatic discharge can be prevented more effectively. When three types of elements including the diode 330, the capacitor 310, and the resistor element 320 are used altogether, the damage due to electrostatic discharge can be prevented more appropriately by disposing the resistor element 320, the capacitor 310, and the diode 330 in the described order from the pixel electrode 21 side.

As described above, according to the electrophoretic display device of the fifth embodiment, the diode 330 is disposed, and accordingly, a damage of the switching circuit 110 due to electrostatic discharge at the time of manufacture can be prevented effectively.

### Electronic Apparatus

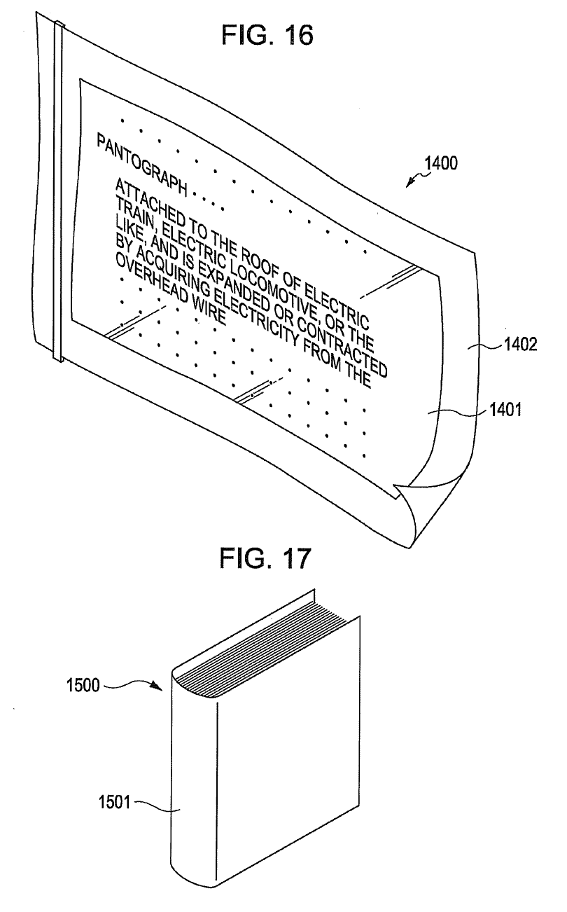

Next, electronic apparatuses in which the above-described electrophoretic display device is used will be described with reference to FIGS. 16 and 17. Hereinafter, cases where the above-described electrophoretic display devices are used in an electronic paper sheet and an electronic notebook will be described as examples.

FIG. 16 is a perspective view showing the configuration of an electronic paper sheet 1400.

As shown in FIG. 16, the electronic paper sheet 1400 includes the electrophoretic display device according to each of the above-described embodiments as a display unit 1401. The electronic paper sheet 1400 has flexibility and is configured to include a main body 1402 formed of a rewritable sheet having same texture and flexibility as those of a general paper sheet.

FIG. 17 is a perspective view showing the configuration of an electronic notebook 1500.

As shown in FIG. 17, the electronic notebook 1500 is formed by binding a plurality of the electronic paper sheets 1400 shown in FIG. 16 and inserting the electronic paper sheets into a cover 1501. The cover 1501 includes a display data inputting unit that receives display data (not shown), for example, transmitted from an external apparatus. Accordingly, the content of display can be changed or updated in accordance with the display data in a state that the electronic paper sheets are bound.

In the electronic paper sheet 1400 and the electronic notebook 1500 described above, the electrophoretic display device according to the above-described embodiment is included, and thereby the electronic paper sheet 1400 and the electronic notebook 1500 can be manufactured in an easy manner and have high reliability.

In addition, in a display unit of an electronic apparatus such as a wrist watch, a cellular phone, or a mobile instrument, the electrophoretic display device according to the above-described embodiment can be used.

In addition, the electrophoretic display device according to this embodiment can be applied to organic EL (electro-luminescence) display.

The invention is not limited to the above-described embodiments, and the embodiments may be appropriately changed without departing from the scope of the gist or idea of the invention which can be read from the Claims and descriptions here. Thus, an electrophoretic device that have such changes therein, and an electronic apparatus that is configured to include the electrophoretic display device belongs to the technical scope of the invention.

The entire disclosure of Japanese Patent Application No. 2008-141149, filed May 29, 2008 is expressly incorporated by reference herein.

What is claimed is:

1. An electrophoretic display device that is formed by pinching an electrophoretic element containing electrophoretic particles between one pair of substrates, the electrophoretic display device comprising a display unit that is formed of a plurality of pixels,
wherein one substrate of the one pair of substrates includes:
a pixel electrode and a pixel switching element that are formed for each of the plurality of pixels;
a memory circuit that is electrically connected between the pixel electrode and the pixel switching element and can hold an image signal supplied through the pixel switching element; and
an electrostatic protection unit that is electrically connected between the pixel electrode and the memory circuit and is formed of at least one of a capacitor element, a resistor element, and a diode.

2. The electrophoretic display device according to claim 1, further comprising:
a first control line;
a second control line; and
a switching circuit that electrically connects either the first control line or the second control line to the pixel electrode in accordance with an output signal on the basis of the image signal that is output from the memory circuit,
wherein the electrostatic protection unit is electrically connected between the pixel electrode and the switching circuit.

3. The electrophoretic display device according to claim 1, further comprising a holding electric potential supplying line that is used for supplying a holding electric potential for holding the image signal to the memory circuit,
wherein the electrostatic protection unit includes a first capacitor element that is formed by pinching a dielectric film between one capacitor electrode that is electrically connected to the pixel electrode and another capacitor electrode that is electrically connected to the holding electric potential supplying line.

4. The electrophoretic display device according to claim 2, wherein the electrostatic protection unit includes a second capacitor element that is formed by pinching a dielectric film between one capacitor electrode that is electrically connected to the pixel electrode and another capacitor electrode that is electrically connected to either the first control line or the second control line.

5. The electrophoretic display device according to claim 1, wherein the electrostatic protection unit includes a first resistor element that is formed of a same film as a semiconductor film that configures a transistor included in the memory circuit.

6. The electrophoretic display device according to claim 1,
wherein the electrostatic protection unit includes the resistor element and at least one between the capacitor element and the diode, and
wherein the resistor element is disposed on a side close to the pixel electrode relative to the capacitor element and the diode so as to be electrically connected to the pixel electrode.

7. An electronic apparatus comprising the electrophoretic display device according to claim 1.
